(19) United States
(12) Patent Application Publication
(10) Pub. No.: US 2014/0001137 A1
(43) Pub. Date: Jan. 2, 2014

(54) CRANE HAVING A CRANE JIB, IN PARTICULAR A BRACKET CRANE

(71) Applicants: Timo Gryzan, Monheim (DE); Peter Köhn, Dusseldorf (DE); Eberhard Becker, Hagen (DE); Dieter Eichler, Leverkusen (DE); Björn Winter, Wetter (DE); Michael Kaminski, Bochum (DE)

(72) Inventors: Timo Gryzan, Monheim (DE); Peter Köhn, Dusseldorf (DE); Eberhard Becker, Hagen (DE); Dieter Eichler, Leverkusen (DE); Björn Winter, Wetter (DE); Michael Kaminski, Bochum (DE)

(73) Assignee: Demag Cranes & Components GmbH, Wetter (DE)

(21) Appl. No.: 13/988,682

(22) PCT Filed: Nov. 18, 2011
(86) PCT No.: PCT/EP2011/070430

§ 371 Date: Jun. 18, 2013

(30) Foreign Application Priority Data
Nov. 26, 2010 (DE) 10 2010 060 846.7

(51) Int. Cl. B66C 19/00

(52) U.S. Cl. CPC B66C 19/00
USPC 212/71

(57) ABSTRACT

A crane comprising a laterally projecting crane jib on which a hoisting device is arranged and which is connected to at least one carrier body, which, together with the crane jib, can travel along an upper guide rail and a lower guide rail by way of traveling gears, wherein in each case the upper and the lower guide rails, and correspondingly, the traveling gears, are arranged spaced vertically from one another. In order to provide a crane comprising a laterally projecting crane jib, in particular a bracket crane or a traveling crane, the manufacture, transport and installation of which are optimized, according to the invention the at least one carrier body is designed as one component and connecting surfaces are arranged on said carrier body, to which a respective traveling gear and the crane jib can be detachably fastened.

### CROSS REFERENCE TO RELATED APPLICATIONS

The present application claims the priority benefits of International Patent Application No. PCT/EP2011/070430, filed on Nov. 18, 2011, and also of German Patent Application No. DE 10 2010 060 846.7, filed on Nov. 26, 2010, which are hereby incorporated herein by reference in their entireties.

### BACKGROUND OF THE INVENTION

The invention relates to a crane having a laterally projecting crane jib on which a hoisting device is disposed and which is connected to at least one support body which, together with the crane jib, can travel along an upper running rail and a lower running rail via travelling mechanisms, wherein in each case the upper and the lower running rails and accordingly the travelling mechanisms are disposed so as to be vertically spaced apart from each other.

European patent document EP 0 544 139 B1 discloses a bracket crane for moving loads by means of at least one crane jib. A hoisting device is accommodated on the crane jib so as to be able to travel by means of a trolley and is used to raise and lower the load. The crane jib is guided on, and can travel along, an upper and lower running rail in a freely laterally projecting manner on one end via an upper and a lower travelling mechanism. The travelling mechanisms each comprise two running wheels and are attached to the crane jib so as to be offset with respect to each other horizontally and vertically in relation to the longitudinal direction of the crane jib. The running rails extend in parallel with each other horizontally and transversely with respect to the crane jib and are attached to a wall or an elevated support structure. The lower travelling mechanism is attached by means of a downwardly directed vertical holder to an end of the crane jib remote from the free end of the crane jib. The running wheels of the lower travelling mechanism run on a lower side of the lower running rail. The running wheels of the upper travelling mechanism run on the upper running rail. The upper travelling mechanism is attached directly to the crane jib. In this manner, the forces or moments resulting from the acceleration or own weight of the crane elements and any load are fed into the running rails or supports via the running wheels of the travelling mechanisms. The crane jib may also be pivotable in a horizontal plane.

German patent document DE 1 135 640 B discloses a comparable bracket crane having a crane jib which is fixedly connected to a bracket acting as a travelling mechanism girder. The bracket crane consists substantially of two parts which are fixedly connected together at the destination of the bracket crane. The frame-shaped bracket is composed of a T-shaped girder and a U-shaped girder for this purpose. The crane jib is fixedly connected to a horizontal region of the T-shaped girder. The T-shaped girder is also fixedly connected at its two ends, in each case via a flange, to each vertical limb of the U-shaped girder. Disposed on the base of the T-shaped girder and, in a vertically offset manner, on the limbs of the U-shaped girder of the assembled bracket are pairs of travelling mechanisms or running wheels for feeding forces or moments into an upper and a lower longitudinal rail and for travelling on the longitudinal rails.

German laid-open document DE 100 21 297 A1 discloses a bridge crane having a main girder which can travel transversely with respect to its longitudinal direction along two running rails extending in parallel. For this, a head girder provided with travelling mechanisms is disposed in each case on the opposite ends of the main girder and the head girders are used to support the main girder on the running rails. The head girders are releasably attached by means of screws to the main girder via in each case a connection part having angle plates. A hoisting device is also suspended on the main girder and can travel along the main girder.

Comparable bridge cranes having main girders fixedly screwed to head girders are also known from documents DE 1 229 262 A and DE 1 175 840 A, laid open for public inspection.

### SUMMARY OF THE INVENTION

The object of the invention is to provide a crane having a laterally projecting crane jib, in particular a bracket crane or travelling crane, whose manufacture, transport and assembly are optimised.

In accordance with an embodiment of the invention, in the case of a crane having a laterally projecting crane jib on which a hoisting device is disposed and which is connected to at least one support body which, together with the crane jib, can travel along an upper running rail and a lower running rail via travelling mechanisms, wherein in each case the upper and the lower running rails and accordingly the travelling mechanisms are disposed so as to be vertically spaced apart from each other, assembly, transport and manufacture are facilitated by virtue of the fact that the at least one support body is formed as a structural unit and on which connection surfaces are disposed, to which in each case one of the travelling mechanisms and the crane jib can be releasably attached. Owing to the separation, in manufacturing, of the support body and crane jib, it is advantageously possible to combine different materials. For example, the support body can consist of an aluminium alloy or of composite materials and the crane jib can consist of a steel material.

The crane in accordance with the invention having a laterally projecting crane jib is also referred to as a bracket crane. This bracket crane differs from the previously described bridge cranes in that the main girder of a bridge crane extends between two running rails extending spaced apart from each other in a horizontal plane and lies with its two ends on the running rails for example via travelling mechanisms. The main girder of such a bridge crane is thus not a freely projecting crane jib in terms of the present invention. A projecting crane jib of a bracket crane comprises a free first end. The free first end is neither attached to a support body of the bracket crane nor does it lie on a running rail. In other words, a support body is connected merely to a second end of the crane jib and faces the running rails and is remote from the free first end. In the case of a bracket crane formed as a travelling crane, the running rails extend vertically spaced apart from each other along a wall. The travelling mechanisms, via which such a bracket crane or travelling crane travels along the running rails, are thus disposed in the region of the non-free second end of the crane jib and the support body located in this position.

Optimisation of manufacturing in the sense that in particular the support body can be manufactured in a single clamping step is achieved by virtue of the fact that all of the connection surfaces are disposed on the at least one support body. Consequently, it is also possible to achieve particularly high manufacturing accuracy. Therefore, the support body or the connection surfaces exclusively disposed thereon, in particular the connection surfaces for the travelling mechanisms, are particular dimensionally stable which means that alignment effort during assembly and disassembly can be reduced. The high manufacturing accuracy moreover results in improved travelling behaviour of the crane, whereby dynamic effects are reduced, the wear of mechanical components such as for example the running wheels is reduced and the service life of the crane is increased.

A modular crane construction is achieved by virtue of the fact that a crane jib connection surface is disposed on the crane jib and a travelling mechanism connection surface is disposed on each travelling mechanism, whereby simplified and separate transport of the travelling mechanisms and of the crane jib to the destination is possible.

Simplified manufacture is additionally achieved by virtue of the fact that connection bores are provided on the connection surfaces, crane jib bores are provided on the crane jib connection surface and housing bores are provided on the travelling mechanism connection surfaces.

In a constructionally simple structure, provision is made that one of the travelling mechanism connection surfaces is disposed on a lateral first or second housing wall of the travelling mechanism.

For simple and rapid assembly, disassembly and simple replacement of components at the destination of the crane, it is particularly advantageous that all of the travelling mechanisms and the crane jib can be attached to one of the connection surfaces in each case via releasable connection means.

In a constructionally simple structure, two travelling mechanisms vertically spaced apart from each other are disposed on the at least one support body and act in mutually opposite directions with regard to the forces introduced from the crane jib. The forces acting on the laterally projecting crane jib are hereby reliably fed into the running rails.

An embodiment which is improved in particular with regard to stability and running smoothness makes provision that a third travelling mechanism is disposed on the at least one support body and, with regard to the forces introduced from the crane jib, acts in a direction which is different from the corresponding directions of the first and second travelling mechanisms.

In a particularly advantageous embodiment the travelling mechanisms each comprise at least one running wheel.

The costs in particular in relation to maintaining required manufacturing tolerances can additionally be minimised in that the at least one running rail comprises at least one running surface which is the surface of a rail disposed on the at least one running rail. This additional rail can be particularly effectively machined in a calculated manner.

The good spatial coverage achieved by the laterally projecting crane jib is additionally increased and made flexible in that the hoisting device can travel along the crane jib.

An exemplified embodiment of the invention is explained in more detail with the aid of the following description.

### BRIEF DESCRIPTION OF THE DRAWINGS

FIG. 1 shows a perspective view of a crane which is formed as a travelling crane,

FIG. 2 shows a lateral, partial view of the crane of FIG. 1,

FIG. 3 shows a perspective view of a support body of the crane, and

FIG. 4 shows a perspective view of a travelling mechanism of the crane.

### DESCRIPTION OF THE PREFERRED EMBODIMENTS

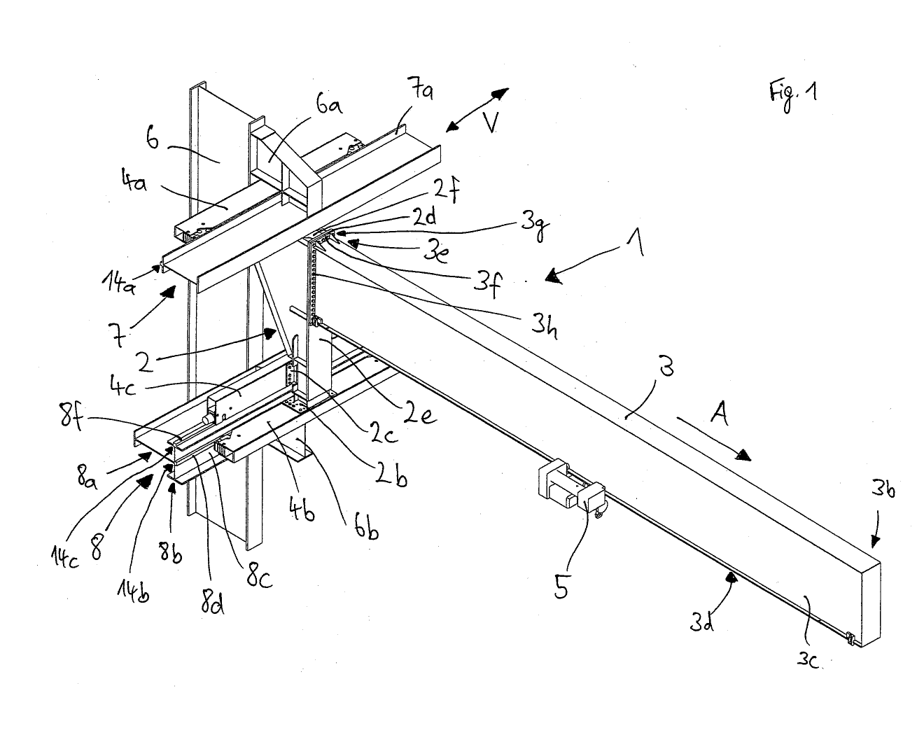

FIG. 1 shows a crane 1 formed as a travelling crane having a support body 2 which can travel on running rails 7, 8 and to which a crane jib 3 is attached so as to project laterally in a projection direction A. The crane jib 3 accommodates a trolley having a hoisting device 5 which can travel along the crane jib 3. Of course, it is also possible to attach a hoisting device to the crane jib 3 in a positionally-fixed manner. It is further possible to dispose more than one crane jib 3 on the support body 2 and on the other hand to suspend more than one trolley having a hoisting device 5 on each crane jib 3 either in a positionally fixed manner or in a manner permitting travel.

A first, second and third travelling mechanism 4a, 4b and 4c are attached to the support body 2. The crane 1 is supported via the travelling mechanism 4a on an upper running rail 7 and via the travelling mechanisms 4b, 4c on a lower running rail 8. The upper running rail 7 and the lower running rail 8 are attached to a vertical girder 6 via a support structure 6a, 6b, which girder is, or can be, a component of a wall, not illustrated. The crane 1 can thus travel as a travelling crane along the upper and lower running rails 7 and 8 and in a substantially horizontal direction of travel V. In a departure from the embodiment as a travelling crane, the girder 6 which supports the upper and lower running rails 7, 8 can also be a free-standing component of a column structure which is not directly a component of a wall.

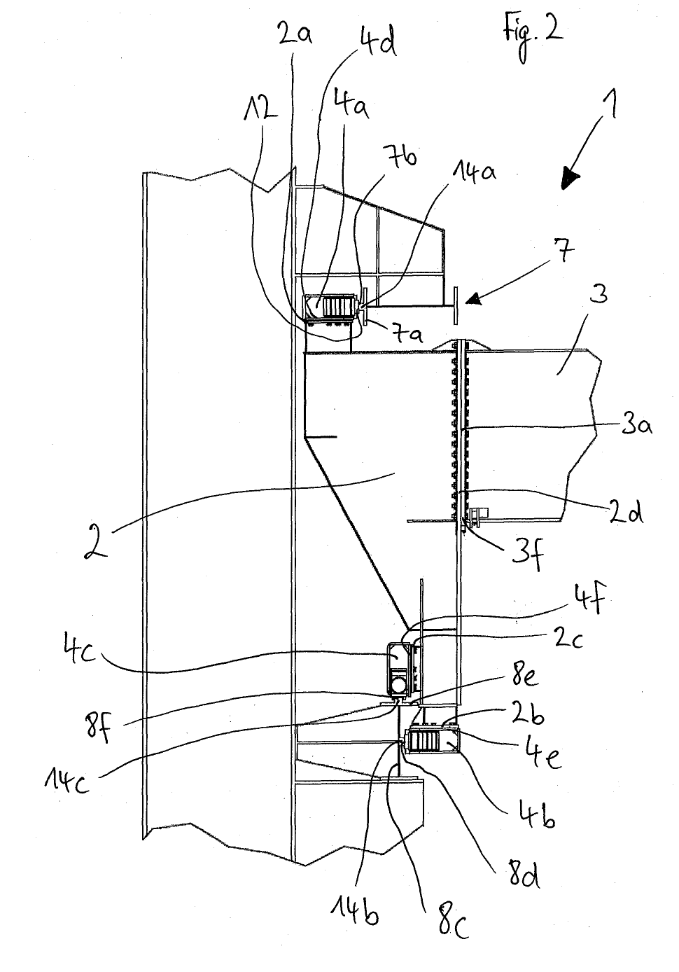

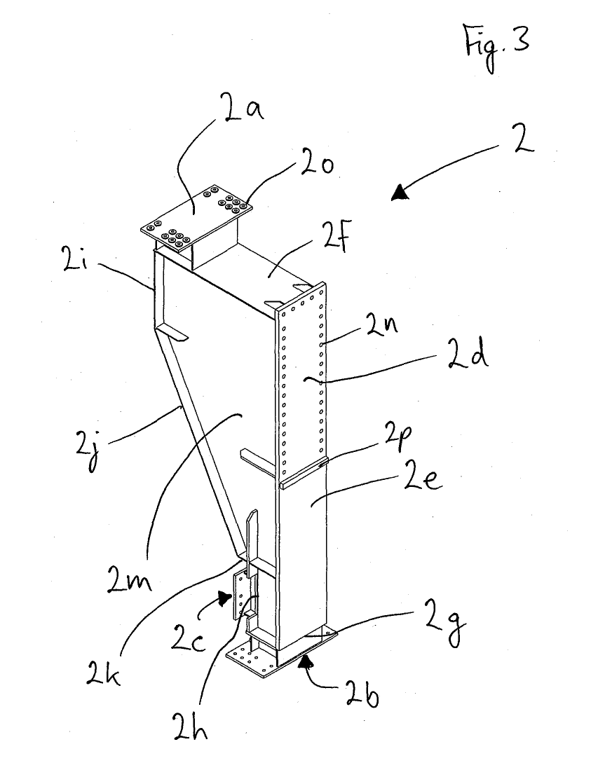

The support body 2 has a flat, elongate rectangular shape having protrusions and comprises a total of four connection surfaces 2a to 2d which will be described in more detail hereinafter (see also FIGS. 2 and 3) and, as seen in a plane containing the projection direction A, are directed in different directions arranged perpendicularly with respect to each other—in particular upwards and downwards in, opposite and transversely with respect to the projection direction A. The connection surfaces 2a to 2d are located indirectly or directly on walls 2e to 2h of the support body 2 (see also FIG. 3).

The fourth connection surface 2d, to which the crane jib 3 is attached on one side by means of a releasable screw connection via a crane jib connection surface 3a (see FIG. 2), is provided in the lateral fourth wall 2e of the support body 2. Therefore, a free end 3b of the crane jib 3 freely projects from the support body 2 in the projection direction A perpendicularly directed away with respect to the direction of travel V. The crane jib 3 is formed to be flat, box-shaped and elongate in the projection direction A, i.e., it has a greater height than width as seen in the projection direction A. The crane jib 3 also has in addition to a free end 3b an opposite connection end 3e. In order to be able to provide a rail-like lower region 3d of the crane jib 3 which is used to accommodate and move the trolley having the hoisting device 5 in or opposite the projection direction A, two opposite-lying lateral crane jib walls 3c are set back inwardly transversely with respect to the projection direction A of the crane jib 3. The crane jib connection surface 3a is provided on the connection end 3e in the form of a connection plate 3g. As seen from the free end 3b, the only part of the connection plate 3g which can be seen is a flange-like collar 3f which protrudes beyond the cross-sectional contour of the crane jib 3 laterally and at the top in a collar-like manner. Several crane jib bores covered by screws 3h are provided in the protruding collar 3f of the connection plate 3g and are disposed in a complementary manner with respect to several connection bores 2n (see FIG. 3) of the fourth connection surface 2d. The crane jib bores and thus also the screws 3h are evenly distributed along the collar 3f. Of course, it is also possible for the crane jib 3 to be formed as a profiled girder consisting of commercially available rolled profiles or of specialised profiles formed in a different manner, instead of the box shape illustrated in this case.

An upwardly directed first connection surface 2a (see FIGS. 2 and 3) is provided on a horizontal upper first wall 2f of the support body 2 and a downwardly directed second connection surface 2b in parallel with the first connection surface 2a is provided on a horizontal lower second wall 2g (see FIGS. 2 and 3) of the support body 2. In addition, a third connection surface 2c is provided on a lateral third wall 2h (see FIGS. 2 and 3) of the support body 2, which third connection surface lies opposite the fourth wall 2e and is directed away therefrom.

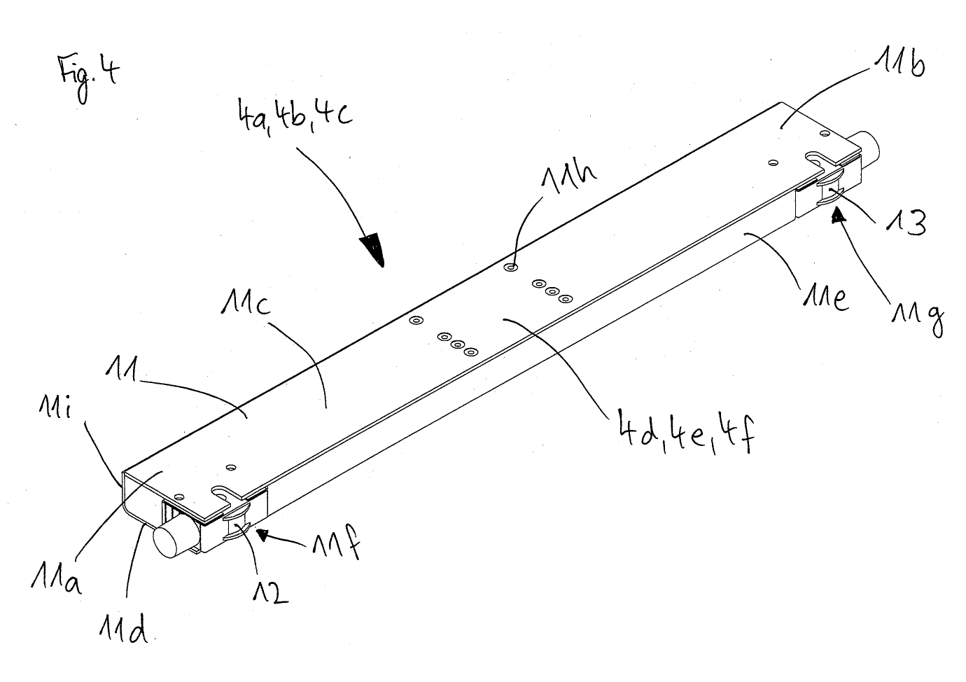

The travelling mechanisms 4a, 4b, 4c are each designed with an identical construction. A main component is an elongate and tubular travelling mechanism housing 11 having a rectangular cross-section. The travelling mechanism housing 11 comprises in each case a travelling mechanism connection surface 4d, 4e, 4f, not illustrated, and in each case a first and second running wheel 12, 13 are mounted therein in a rotatable manner (see FIG. 4). The first travelling mechanism 4a is attached to the support body 2 by means of a releasable screw connection between the first travelling mechanism connection surface 4d and the first connection surface 2a, and the second travelling mechanism 4b is attached to the support body 2 by means of a releasable screw connection between the second travelling mechanism connection surface 4e and the second connection surface 2b. The third travelling mechanism 4c is attached to the support body 2 by means of a releasable screw connection between the third travelling mechanism connection surface 4f and the third connection surface 2c.

The upper running rail 7 is formed in the shape of an I girder having a web and two flanges and extends in the direction of travel V, wherein the web is oriented horizontally. On a rear—as seen from the free end 3b of the crane jib 3—first flange 7a, a first rail 14a extending in the direction of travel V—i.e., in the longitudinal direction of the upper running rail 7—and having a rectangular cross-section is welded on the outside at the level of the web. The surface, not illustrated, of the first rail 14a acts as a vertical first running surface 7b (see FIG. 2) which has the first travelling mechanism 4a lying against it.

The lower running rail 8 consists of a T-girder-shaped first region 8a having a web and a flange. The first region 8a is disposed below the upper running rail 7. The web of the first region 8a is also aligned in parallel with the upper running rail 7, wherein the end of the web remote from the flange is directed in the direction of the free end 3b of the crane jib 3. This end of the web of the first region 8a is laterally attached to an I-shaped second region 8b of the lower running rail 8 having a web 8c and two flanges and is attached centrally to the web 8c. The web of the first region 8a is disposed perpendicularly with respect to the web 8c of the second region 8b. Provided on the lower running rail 8 is a vertical second running surface 8d, which has the second travelling mechanism 4b lying against it, by virtue of the fact that a second rail 14b is welded in the longitudinal direction on the side of the web 8c directed in the projection direction A at the level of the web of the first region 8a. A horizontal third running surface 8f on the lower running rail 8, which has the third travelling mechanism 4c lying against it, is provided by virtue of the fact that a third rail 14c is welded centrally and in the longitudinal direction on an upper second flange 8e. The contacting relationships between the travelling mechanisms 4a, 4b, 4c and the rails 14a, 14b, 14c or the running surfaces 7b, 8d, 8f are shown in detail in FIG. 2.

Owing to the described construction of the crane 1, the occurring moments and the horizontal or vertical forces resulting therefrom are fed into the upper running rail 7 and into the lower running rail 8 substantially via the travelling mechanisms 4a, 4b and 4c corresponding to the respective travelling mechanism orientation.

The orientation of the travelling mechanism connection surfaces 4d and 4e and thus of the first and second travelling mechanism 4a and 4b in the assembled state can also be effected, in addition to the illustrated horizontal orientation, vertically or in an angled intermediate position if the upper or lower running rail 7 or 8 respectively are reconfigured accordingly. This is also true for the third travelling mechanism 4c and the corresponding third travelling mechanism connection surface 4f.

FIG. 2 illustrates a lateral, partial view of the crane 1, in particular the screw connections between the crane jib connection surface 3a of the collar 3f and the fourth connection surface 2d, between the first travelling mechanism connection surface 4d and the first connection surface 2a, between the second travelling mechanism connection surface 4e and the second connection surface 2b and between the third travelling mechanism connection surface 4f and the third connection surface 2c. It is also shown how the first running wheel 12 and the second running wheel 13, not illustrated, of the first travelling mechanism 4a are in contact with, and roll on, the first running surface 7b. The contacting relationships between the travelling mechanism 4b and 4c and the second running surface 8d and third running surface 8f respectively are also shown.

FIG. 3 illustrates the support body 2 having the four connection surfaces 2a to 2d which are provided on the walls 2e to 2h. The substantially box-shaped design of the support body 2 has, on a side opposite the fourth wall 2e, a wall progression which substantially drops back in an inclined manner and is formed by further walls 2i to 2k. The vertical fifth wall 2i, directed downwards, adjoins the upper first wall 2f opposite, and in parallel with, the fourth wall 2e. The distance of the wall progression in relation to the fourth wall 2e decreases constantly and linearly over an inclined region and ends with a set-back step on the vertical third wall 2h. Therebetween, the sixth wall 2j which extends in an inclined manner adjoins at the top the fifth wall 2i and at the bottom the horizontal wall 2k connected to the third wall 2h. The frame formed by the aforementioned seven walls 2e to 2k is closed on both sides by two sidewalls 2m, wherein the sidewalls 2m are each set back inwardly with respect to the outer edges of the frame. The fourth connection surface 2d is formed integrated in the sidewall 2e, wherein several connection bores 2n are provided in an evenly distributed manner in a U-shaped progression in an upper edge region of the fourth wall 2e. The connection surfaces 2a, 2b, 2c, which are attached indirectly to the support body 2 in the form of connection plates, each have several connection bores having insertion sleeves 2o. Of course, the connection surfaces 2a to 2d can also be embodied in a manner different from that illustrated. It is also possible that some of the connection surfaces 2a to 2d are disposed adjacently such that the corresponding surfaces merge into each other and only the connection of the travelling mechanisms 4a, 4b, 4c or of the crane jib 3 effects local delimitation. For example, it is also feasible that two crane jibs 3 are attached to the support body 2 and for this two separate connection surfaces are provided from the outset, or that a common connection surface accommodates the two crane jibs 3. Moreover, a projecting edge 2p formed in a rod-shaped manner having a rectangular cross-section is disposed on the fourth wall 2e so as to be oriented in a horizontal transverse manner. The upper side of the projecting edge 2p is used as an abutment on which the lower region 3d of the connection end 3e of the crane jib 3 lies during assembly and in the assembled state.

FIG. 4 shows exemplarily a perspective view of the construction of a travelling mechanism 4a, 4b, 4c. Between two elongate and parallel housing walls 11c, 11d of the box-shaped travelling mechanism housing 11 the first running wheel 12 is mounted in a rotatable manner on a left end 11a and the second running wheel 13 is mounted in a rotatable manner on a right end 11b. The running wheels 12, 13 each protrude, on the left or right end 11a, 11b respectively of the travelling mechanism 11, partly from in each case a left and a right opening 11f, 11g of a third housing wall 11e. Alternatively, it is also possible to accommodate more than two running wheels in the travelling mechanism housing 11. In addition, several housing bores 11h are provided in the first housing wall 11c or in the second housing wall 11d in the region of the travelling mechanism connection surfaces 4d, 4e, 4f, wherein the respective screwing of the travelling mechanisms 4a, 4b, 4c to the corresponding connection surfaces 2a, 2b, 2c of the support body 2 is effected via the housing bores. In a departure from the embodiment illustrated in FIGS. 1, 2 and 4, it is likewise possible that the housing bores 11h are not provided in the lateral first or second housing walls 11c, 11d but are provided in an upper fourth housing wall 11i. A travelling mechanism 4a, 4b, 4c formed in this manner would thus be connected to the support body 2 not as a “lateral connection” but as an “upper connection”—in relation to the upper housing wall 11i thereof and independent of its spatial orientation in the assembled state. Each of the travelling mechanisms 4a, 4b, 4c can be designed to be driven or non-driven.

### LIST OF REFERENCE NUMERALS

1 Crane
2 Support body
2a First connection surface
2b Second connection surface
2c Third connection surface
2d Fourth connection surface
2e Fourth wall
2f First wall
2g Second wall
2h Third wall
2i Fifth wall
2j Sixth wall
2k Seventh wall
2m Sidewall
2n Connection bore
2o Connection bore having insertion sleeve
2p Projecting edge
3 Crane jib
3a Crane jib connection surface
3b Free end
3c Crane jib wall
3d Lower region
3e Connection end
3f Collar
3g Connection plate
3h Screws
4a First travelling mechanism
4b Second travelling mechanism
4c Third travelling mechanism
4d First travelling mechanism connection surface
4e Second travelling mechanism connection surface
4f Third travelling mechanism connection surface
5 Trolley having hoisting device
6 Girder
6a Upper support structure
6b Lower support structure
7 Upper running rail
7a First flange
7b First running surface
8 Lower running rail
8a First region
8b Second region
8c Web
8d Second running surface
8e Second flange
8f Third running surface
11 Travelling mechanism housing
11a Left end
11b Right end
11c First housing wall
11d Second housing wall
11e Third housing wall
11f Left opening
11g Right opening
11h Housing bore
11i Fourth housing wall
12 First running wheel
13 Second running wheel
14a First rail
14b Second rail
14c Third rail
A Projection direction
V Direction of travel

1. Crane having a laterally projecting crane jib on which a hoisting device is disposed and which is connected to at least one support body which, together with the crane jib, can travel along an upper running rail and a lower running rail via travelling mechanisms, wherein in each case the upper and the lower running rails and accordingly the travelling mechanisms are disposed so as to be vertically spaced apart from each other, characterised in that the at least one support body is formed as a structural unit and on which connection surfaces are disposed, to which in each case one of the travelling mechanisms and the crane jib can be releasably attached.

2. Crane as claimed in claim 1, wherein all of the connection surfaces are disposed on the at least one support body.

3. Crane as claimed in claim 2, wherein a crane jib connection surface is disposed on the crane jib and a travelling mechanism connection surface is disposed on each travelling mechanism.

4. Crane as claimed in claim 3, wherein connection bores are provided on the connection surfaces, crane jib bores are provided on the crane jib connection surface and housing bores are provided on the travelling mechanism connection surfaces.

5. Crane as claimed in claim 4, wherein one of the travelling mechanism connection surfaces is disposed on a lateral first or second housing wall of the travelling mechanism.

6. Crane as claimed in claim 3, wherein all of the travelling mechanisms and the crane jib can be attached to one of the connection surfaces in each case via releasable connection means.

7. Crane as claimed in claim 3, wherein two travelling mechanisms vertically spaced apart from each other are disposed on the at least one support body and act in mutually opposite directions with regard to the forces introduced from the crane jib.

8. Crane as claimed in claim 7, wherein a third travelling mechanism is disposed on the at least one support body and, with regard to the forces introduced from the crane jib, acts in a direction which is different from the corresponding directions of the first and second travelling mechanisms.

9. Crane as claimed in claim 3, wherein the travelling mechanisms each comprise at least one running wheel.

10. Crane as claimed in claim 3, wherein the at least one running rail comprises at least one running surface which is the surface of a rail disposed on the at least one running rail.

11. Crane as claimed in claim 3, wherein the hoisting device can travel along the crane jib.

12. Crane as claimed in claim 3, wherein one of the travelling mechanism connection surfaces is disposed on a lateral first or second housing wall of the travelling mechanism.

13. Crane as claimed in claim 1, wherein a crane jib connection surface is disposed on the crane jib and a travelling mechanism connection surface is disposed on each travelling mechanism.

14. Crane as claimed in claim 13, wherein connection bores are provided on the connection surfaces, crane jib bores are provided on the crane jib connection surface and housing bores are provided on the travelling mechanism connection surfaces.

15. Crane as claimed in claim 13, wherein one of the travelling mechanism connection surfaces is disposed on a lateral first or second housing wall of the travelling mechanism.

16. Crane as claimed in claim 1, wherein all of the travelling mechanisms and the crane jib can be attached to one of the connection surfaces in each case via releasable connection means.

17. Crane as claimed in claim 1, wherein two travelling mechanisms vertically spaced apart from each other are disposed on the at least one support body and act in mutually opposite directions with regard to the forces introduced from the crane jib.

18. Crane as claimed in claim 17, wherein a third travelling mechanism is disposed on the at least one support body and, with regard to the forces introduced from the crane jib, acts in a direction which is different from the corresponding directions of the first and second travelling mechanisms.

19. Crane as claimed in claim 1, wherein the travelling mechanisms each comprise at least one running wheel.

20. Crane as claimed in claim 1, wherein the at least one running rail comprises at least one running surface which is the surface of a rail disposed on the at least one running rail.

21. Crane as claimed in claim 1, wherein the hoisting device can travel along the crane jib.
